(19) United States
(12) Patent Application Publication
(10) Pub. No.: US 2014/0272924 A1
(43) Pub. Date: Sep. 18, 2014

(54) TRANSPLANTATION AND GROWTH OF HUMAN FETAL ORGANS IN NON-HUMAN ANIMAL HOSTS

(71) Applicant: Ganogen, Inc., Stanford, CA (US)

(72) Inventors: Nicholas Chang, San Leandro, CA (US); Jay Gu, San Leandro, CA (US); Eugene Gu, San Leandro, CA (US); Don Hannula, San Luis Obispo, CA (US)

(73) Assignee: Ganogen, Inc., Stanford, CA (US)

(21) Appl. No.: 14/205,871

(22) Filed: Mar. 12, 2014

Related U.S. Application Data
(60) Provisional application No. 61/782,674, filed on Mar. 14, 2013.

(51) Int. Cl. A01N 1/02

(52) U.S. Cl. CPC A01N 1/021
USPC 435/1.2; 435/1.1

(57) ABSTRACT

Embodiments described herein relate generally to devices, systems and methods for transplanting and growing human fetal organs within non-human animal hosts. In some embodiments, a method for transplanting an organ from a human fetus in a non-human animal host includes fluidically coupling the fetal organ to the blood circulation system of an immunocompromised non-human animal host such that the organ receives arterial blood flow from the non-human animal host. The blood pressure of the arterial blood flow entering the fetal organ is controlled to be compatible with the blood pressure of the organ from the human fetus. In some embodiments, the blood pressure of the blood flow to the fetal organ is controlled using a blood flow control device that includes an inflatable cuff in pressure contact with a blood vessel of the non-human animal host.

### CROSS-REFERENCE TO RELATED APPLICATIONS

This application claims priority to and the benefit of U.S. Provisional Application No. 61/782,674, entitled “Transplantation and Growth of Human Fetal Organs in Non-Human Animal Hosts,” filed Mar. 14, 2013, the disclosure of which is incorporated by reference herein in its entirety.

### BACKGROUND

Embodiments described herein relate generally to devices, systems and methods for transplanting and growing human fetal organs within non-human animal hosts.

Human fetal organs obtained from aborted or non-viable fetuses can be used as donor organs for patients, for example, babies or adult patients that require an organ transplant, for drug testing, screening and discovery, and/or for general experimentation. Fetal organs need to be grown in a host vehicle, for example, an animal such as rats, mice, pigs, cats, dogs or primates, until they are mature enough to be transplanted into the patient. Human fetal blood pressure is typically 30 mmHg at 20 weeks gestation and 45 mmHg at 30 weeks gestation, thus, human fetal organs are accustomed to blood pressure in these ranges. The mean blood pressure of most adult animals, including mice, rats, and pigs is about 100 mmHg, almost three times the pressure of a fetal organ. This high blood pressure can subject the transplanted fetal organ to hypertensive crisis and eventually lead to organ failure.

Furthermore, the non-human animal host's immune system, which includes immune cells such as B-cells, T-cells, and complement cascade, recognizes the transplanted organ as a foreign body and attacks the transplanted organ rendering it non-viable. Also, the blood of the host animal does not include all of the biochemicals required by the transplanted fetal organ for proper growth and development such as, for example, hormones, growth factors and/or other nutrients.

Thus new technologies are needed that can enable the sustenance and growth of transplanted fetal organs in non-human host animals which can provide the physiological parameters closely resembling that of the fetus from which the organ was originally explanted.

### SUMMARY

Embodiments described herein relate generally to devices, systems and methods for transplanting and growing human fetal organs within non-human animal hosts. In some embodiments, a method for transplanting an organ from a human fetus into a non-human animal host includes fluidically coupling the fetal organ to the blood circulation system of an immunocompromised non-human animal host such that the organ receives arterial blood flow from the non-human animal host. Furthermore, the blood pressure of the arterial blood flow entering the fetal organ is controlled to be compatible with the blood pressure of the organ from the human fetus. In some embodiments, the blood pressure of the blood flow to the fetal organ is controlled using a blood flow control device, which includes an inflatable cuff in pressure contact with a blood vessel of the non-human animal host.

### BRIEF DESCRIPTION OF THE DRAWINGS

FIG. 1 is a schematic illustration of a blood flow control device, according to an embodiment.

FIG. 2 is a perspective view of a blood flow control device, according to an embodiment.

FIG. 3 is an exploded view of the blood control device of FIG. 2.

FIG. 4 is an enlarged view of a region A of the blood flow control device of FIG. 2

FIGS. 5A and 5B are cross-section views of the blood flow control device of FIG. 2 taken along the line B-B in FIG. 4 in a first and second configuration, respectively.

FIG. 6 shows an image of a human fetal kidney transplanted into a non-human animal host.

### DETAILED DESCRIPTION

Embodiments described herein relate generally to devices, systems and methods for transplanting and growing human fetal organs within non-human animals with controlled blood flow to the organ using a blood flow control device. In some embodiments, a method for transplanting an organ from a human fetus into a non-human animal host includes fluidically coupling the fetal organ to the blood circulation system of an immunocompromised non-human animal host such that the organ receives arterial blood flow from the non-human animal host. Furthermore, the blood pressure of the arterial blood flow entering the fetal organ is controlled to be compatible with the blood pressure of the organ from the human fetus. In some embodiments, the blood pressure of the blood flow to the fetal organ is controlled using a blood flow control device, which includes an inflatable cuff in pressure contact with a blood vessel of the non-human animal host.

Human fetal organs, for example, kidney, liver, pancreas, heart or lung, harvested from aborted or non-viable human fetuses of any gestational age, for example, 20 weeks (second trimester) or 30 weeks (third trimester), can be useful as donor organs for human transplant surgery, for drug testing, screening and discovery, and/or general experimentation. For transplantation into an infant or an adult, the fetal organ typically needs to be grown and matured in an environment which has similar physiological parameters as would be experienced by the human fetal organ within the source fetus from which the fetal organ was explanted. For example, human fetal organs can be transplanted to and grown in a non-human animal host such as, for example, rat, mice, pigs, dogs, cats, primates, etc., until they are mature enough for transplantation into a human patient. The non-human animal host environment, however, has certain limitations. For example, human fetal organs are generally accustomed to a blood pressure of 30 mmHg at 20 weeks gestation and 45 mmHg at 30 weeks gestation. The mean blood pressure of most adult animals, including mice, rats, and pigs is about 100 mmHg, which is almost three times the pressure of a fetal organ. This high blood pressure can subject the transplanted fetal organ to hypertensive crisis and eventually lead to organ failure. Therefore, to maintain proper growth and development, the blood pressure to the transplanted human fetal organ needs to be controlled. Systems, devices and methods described herein can be used to reduce the blood pressure to the human fetal organ by reducing blood flow through a blood vessel communicating blood to the fetal organ. In some embodiments, a blood flow control device as described herein can be used to reduce the native blood pressure of the non-human animal host. In some embodiments, the blood pressure can be controlled by the administration of therapeutic agents to the non-human animal host, and/or modification of a cardiovascular system of the non-human animal host.

Furthermore the host animal immune system, which includes immune cells such as B-cells, T-cells, and complement cascade, recognizes the transplanted organ as a foreign body and attacks the transplanted organ rendering it non-viable. Systems, devices and methods described herein, can reduce or nullify the complement cascade of the non-human animal host by using an immunocompromised non-human animal as the host for transplantation of the human fetal organ, as described herein.

In some embodiments, a method for transplanting an organ from a human fetus in a non-human host includes fluidically coupling the organ to the blood circulation system of an immunocompromised non-human animal so that the organ receives arterial blood flow from the non-human animal. The method further includes adjusting the blood pressure of the arterial blood flow entering the animal to be compatible with a blood pressure of the organ from the human fetus, for example, less than 80 mmHg.

In some embodiments a method of growing an organ from a human fetus includes fluidically coupling the fetal organ to an artery of an immunocompromised non-human animal by disposing a vascular cuff assembly on the artery. The vascular cuff assembly is configured to apply pressure to an exterior surface of the artery. The method further includes adjusting the blood pressure of the arterial blood flow from a first blood pressure to a second blood pressure such that the second blood pressure is less than the first blood pressure. In some embodiments, the second blood pressure is compatible with the organ from the human fetus, for example, the second blood pressure is in the range of about 20 mmHg to about 60 mmHg.

In some embodiments, a device for controlling vascular blood flow includes an inflatable reservoir having a first end, a second end, and a port configured to allow fluid communication between the inflatable reservoir and a fluid delivery mechanism. A retainer is disposed on the inflatable reservoir and is configured to position the first end of the inflatable reservoir proximate to the second end of the reservoir. The inflatable reservoir defines a channel for receiving a blood vessel of a non-human animal. In some embodiments, the channel has a first diameter in a first configuration and a second diameter in a second configuration, such that the second diameter is less than the first diameter.

In some embodiments, an immunocompromised non-human animal host includes an organ transplanted from a human fetus such that the organ of the human fetus is supported by the immunocompromised non-human animal. Furthermore, the blood inflow from the non-human animal host to the organ is less than 80 mmHg. In some embodiments, the blood pressure of the blood inflow from the immunocompromised non-human animal to the organ can be between about 20 mmHg-60 mmHg.

In some embodiments, a method for transplanting an organ from a human fetus in a non-human animal host includes fluidically coupling the organ to the blood circulation system of an immunocompromised non-human animal host. The method further includes adjusting the blood pressure of the arterial blood flow entering the fetal organ to be compatible with a blood pressure of the human fetal organ, for example, compatible with a blood pressure in the human fetus from which the fetal organ is harvested. In some embodiments, the artery of the fetal organ is connected to the non-human animal host's infrarenal abdominal aorta below the level of the inferior mesenteric artery but above the bifurcation of the aorta such that the sympathetic vascular tone of the host's lower limbs is reduced via a lumbar sympathectomy, as described herein.

In some embodiments, the human fetal organ can be a kidney which is transplanted into the non-human animal host by anastomosing a human fetal aortic patch connected to the renal artery of the kidney, to a host's artery in proximity to a vein within the host. In some embodiments, the artery from the non-human animal host can be, for example, an abdominal aorta, carotid artery, iliac artery, or femoral artery. Furthermore, the transplantation can also include anastomosing a human inferior vena caval patch connected to the renal vein of the human fetal kidney to a host's vein in proximity to an artery within the host. The vein of the non-human animal host can include, for example, inferior vena cava, external jugular vein, iliac vein, or femoral vein. In some embodiments, the fetal kidney can be transplanted in proximity to a bladder of a host such that the ureter of the kidney is anastomosed to the bladder of the host. This can, for example, allow fluids secreted from the kidney (e.g., excrements) to be communicated directly to the bladder of the host. In some embodiments, a fluid collection device, for example, a miniaturized Foley catheter can be fluidically coupled to the kidney or any other transplanted organ, for example, to receive and collect fluids secreted by the organ.

In some embodiments, the transplanted fetal organ can include a fetal heart. In such embodiments, transplantation can include anastomosing a brachiocephalic artery, left common carotid artery, left subclavian artery and/or aorta of the human fetal heart to the non-human host animal's abdominal aorta, carotid artery, iliac artery, femoral artery or any other artery in proximity to a vein within the host animal. Furthermore, the pulmonary artery of the fetal heart can be anastomosed to the host animal's inferior vena cava, external jugular vein, iliac vein, femoral vein, or any other vein in proximity to an artery within the host animal. In some embodiments, to limit the amount of blood remaining trapped within the left ventricle of the fetal heart due to the inability of the fetal heart to pump against the high afterload of the adult animal various surgical techniques can be employed. For example, the left atrium can be ligated to limit the amount of blood entering the left ventricle and/or the creation of a bypass shunt between the left ventricle and the pulmonary artery to allow blood to escape the left ventricle.

In some embodiments, the transplanted fetal organ can include a fetal liver. In such embodiments, the hepatic artery of the human fetal liver can be anastomosed to the non-human host animal's abdominal aorta, carotid artery, iliac artery, femoral artery or any other artery in proximity to a vein within the host animal. Furthermore, the hepatic vein of the fetal liver can be anastomosed to the host animal's inferior vena cava, external jugular vein, iliac vein, femoral vein, or any other vein in proximity to an artery within the host animal. In some embodiments, if the liver is transplanted into an area within the non-human host animal in proximity to the duodenum, the bile duct of the fetal liver can be directly anastomosed to the duodenum. In some embodiments, if the liver is transplanted into an area distal to the duodenum, an artificial reservoir, for example, a miniaturized Foley catheter can be used to drain the bile into an external location. In some embodiments, if a functional liver is desired, for example, to test the pharmacodynamics of drugs metabolized by the liver, the portal vein of the human fetal liver can be anastomosed to the non-human host animal's portal vein.

In some embodiments, the transplanted fetal organ can include a fetal pancreas. In such embodiments, the pancreatic artery of the human fetal pancreas can be anastomosed to the non-human host animal's abdominal aorta, carotid artery, iliac artery, femoral artery or any other artery in proximity to a vein within the host animal. Furthermore, the pancreatic vein of the fetal pancreas can be anastomosed to the host animal's inferior vena cava, external jugular vein, iliac vein, femoral vein, or any other vein in proximity to an artery within the host animal. In some embodiments, if the pancreas is transplanted into an area close to the small intestines, the pancreatic duct can be anastomosed directly to the small intestine. In some embodiments, if the pancreas is transplanted into an area distal to the small intestines, an artificial reservoir, for example, a miniaturized Foley catheter can be used to drain the pancreatic secretions into an external location.

In some embodiments, the transplanted fetal organ can include a fetal lung. In such embodiments, the bronchial artery of the human fetal pancreas can be anastomosed to the non-human host animal's pulmonary artery, abdominal aorta, carotid artery, iliac artery, femoral artery or any other artery in proximity to a vein within the host animal. Furthermore, the bronchial vein of the fetal lung can be anastomosed to the host animal's pulmonary vein, inferior vena cava, external jugular vein, iliac vein, femoral vein, or any other vein in proximity to an artery within the host animal.

As described herein, the blood flow of the non-human animal host to the transplanted fetal organ is controlled, for example, to be compatible with a blood pressure of a blood flow experienced by the fetal organ within the fetus, from which the organ was explanted. In some embodiments, the blood pressure of the arterial blood flow can be controlled to be less than 80 mmHg. In some embodiments, the blood pressure of the arterial blood flow can be in the range of about 20 mmHg to about 60 mmHg. In some embodiments, the arterial blood flow can be controlled such that the blood flow entering a transplanted human fetal heart is less than 250 ml/min, the blood flow entering a transplanted human fetal kidney is less than 1,250 ml/min, or the blood flow entering a transplanted human fetal liver is less than about 1,500 ml/min.

Various devices and methods can be used to control the blood flow to the transplanted human fetal organ from the non-human animal host. In some embodiments, the blood pressure of the arterial blood flow can be adjusted via a modification of the non-human animal host cardiovascular system. For example, surgical interventions and/or anatomic manipulations can be performed to lower the non-human animal host's blood pressure. In some embodiments, a unilateral or bilateral lumbar sympathectomy is performed on the host animal in which the L1, L2, L3 and L4 sympathetic ganglia are unilaterally or bilaterally surgically removed to reduce a sympathetic vascular tone of the lower limbs. This decreases a vascular resistance in the lower limbs and increases the blood flow demand to the lower limbs of the non-human animal host, such that pressure and flow of arterial blood in the infrarenal abdominal aorta of the host animal is decreased. In such embodiments, the artery of the human fetal organ can be connected to the infrarenal abdominal aorta below the level of the inferior mesenteric artery, but above the bifurcation of the aorta.

In some embodiments, therapeutic agents can also be administered to the host animal to adjust the blood pressure of the blood flow such that, for example, the therapeutic agent lowers the arterial blood pressure of the host. The therapeutic agents can include but are not limited to diuretics, beta blockers, calcium channel blockers, angiotensin converting enzyme inhibitors, and/or sympatholytics.

In some embodiments, a blood vessel of the non-human animal host can be manipulated to adjust the blood pressure of the blood flow of the non-human animal host to the fetal organ. For example, the host blood vessel can be sutured to constrict the blood vessel and decrease blood pressure of the blood flow to the fetal organ. In some embodiments, a pressure can be applied to an exterior surface of the blood vessel providing arterial blood flow to the transplanted fetal organ to adjust the blood pressure of the blood flow. For example, the pressure can be applied by an inflatable cuff disposed on the artery. In some embodiments, the inflatable cuff can be included in a blood flow control device, which can also include a retaining member configured to apply a direct pressure inwards toward the exterior surface of the artery (e.g., when the inflatable cuff is inflated). In some embodiments, adjusting the blood pressure of the blood flow is not required, for example, when the fetal organ is a human fetal lung such that a pulmonary artery of the fetal lung is anastomosed to the host animal's pulmonary artery and a pulmonary vein of the fetal lung is anastomosed to the host animal's pulmonary vein.

As described herein, the non-human host animal immune system that includes immune cells such as B-cells, T-cells, and complement cascade can recognize the transplanted organ as a foreign entity and attack the transplanted organ rendering it non-viable. In some embodiments, the non-human host animal can include an immunocompromised host animal such that the complement cascade of the non-human host animal is compromised, depleted, or otherwise inactive. For example, in some embodiments, the non-human host animal can have a SCID phenotype that lacks circulating T-cells and B lymphocytes, and/or the complement cascade of the non-human host animal can be knocked out using therapeutic agents, e.g., cobra venom factor.

In some embodiments, a method for growing an organ from a human fetus can include fluidically coupling the organ, for example, a kidney, liver, pancreas, heart or lung, to an artery of an immunocompromised non-human animal, for example, a host animal having the SCID phenotype. The organ can be transplanted using any of the surgical procedures or methods described herein. The method also includes disposing a vascular cuff assembly on the artery, for example, an inflatable reservoir included in a blood flow control device as described herein, such that the vascular cuff assembly can apply pressure to an exterior surface of the artery. The vascular cuff assembly is used to adjust the blood pressure of the arterial blood flow from a first pressure to a second pressure such that the second pressure is less than the first blood pressure. For example, the first blood pressure can be the non-human host animal normal blood pressure, and the second blood pressure can be a blood pressure compatible with the blood pressure of the human fetal organ. In some embodiments, the second blood pressure can be in the range of about 20 mmHg-60 mmHg. In some embodiments, the blood pressure of the arterial blood flow can be adjusted from the first blood pressure to the second blood pressure for a first time period. The blood pressure of the arterial blood flow can be further adjusted from the second blood pressure to a third blood pressure for a second time period, such that the third blood pressure is greater than the second blood pressure. In some embodiments, the second blood pressure can be about 25 mmHg-40 mmHg (e.g., the blood pressure of a second trimester fetus), and the third blood pressure can be about 35 mmHg-50 mmHg (e.g., the blood pressure of a third trimester fetus). In some embodiments, therapeutic agents, e.g., diuretics, beta blockers, calcium channel blockers, angiotensin converting enzyme inhibitors, and/or sympatholytics, can also be administered to the host animal to reduce its blood pressure, as described herein. In some embodiments, the growth of the fetal organ can be supported by administering appropriate hormones, including but not limited to human growth hormone (e.g., somatotropin), anabolic steroids, and/or insulin like growth factors, to the non-human animal host and/or directly to the fetal organ.

As described herein, the vascular blood flow of the non-human animal host to the transplanted organ can be controlled using a blood flow control device. FIG. 1 illustrates a schematic block diagram of a blood flow control device 100 that includes a fluid delivery mechanism 110, an inflatable reservoir 120 and a retainer 130. The inflatable reservoir 120 is configured to be reversibly coupleable to a blood vessel BV, for example, a blood vessel of an immunocompromised non-human animal host that has a human fetal organ (e.g., a kidney, liver, pancreas, heart, and/or lung) fluidically coupled to it.

The fluid delivery mechanism 110 is configured to communicate a fluid, for example, saline solution and/or air to the inflatable reservoir 120. In some embodiments, the fluid delivery mechanism 110 can include a valve assembly. A first portion of the valve assembly can be configured to be coupled to a fluid source, for example, a syringe, a pump, a reservoir or any other fluid source. In some embodiments, the valve can be a bi-directional valve, configured to allow fluid to flow through the valve only in the presence of a positive or a negative pressure. For example, the fluid source can apply a positive pressure to a fluid to communicate the fluid through the valve to the inflatable reservoir 120, such that when the positive pressure is removed, the valve prevents the fluid from flowing backwards towards the fluid source. Therefore the valve can allow maintenance of a fluid volume and/or pressure delivered to the inflatable reservoir 120, even after the positive pressure is removed. In some embodiments, the valve can be, for example, an ABS valve, a septum, a flap valve, a membrane valve, an umbrella valve, a duckbill valve, a butterfly valve, or any other suitable valve mechanism.

In some embodiments, a pressure monitoring device can be coupled to the valve assembly, for example, to monitor a pressure of the fluid communicated to the inflatable reservoir 120 and/or a blood pressure of a blood flow of the host animal blood vessel BV. In some embodiments, a second portion of the valve assembly can be coupled to a fluid communicator, for example, a tube, a pipe or a percutaneous fill tube, such that fluid communicator can communicate a fluid from the valve assembly to the inflatable reservoir 120. In some embodiments, the fluid delivery mechanism 110 can include more then one fluid communicator, for example, a first fluid communicator to communicate fluid to the inflatable reservoir 120 and a second fluid communicator to receive fluid from the inflatable reservoir 120. In some embodiments, the fluid delivery mechanism 110 can be configured to deliver adjustable fluid pressures and/or adjustable fluid volumes to the inflatable reservoir 120.

The inflatable reservoir 120 is configured to be removably coupleable to a blood vessel BV of a non-human animal, for example, an immunocompromised non-human animal (e.g., rat, mice, pig, rabbit, dog, cat, or a primate). In some embodiments, the inflatable reservoir 120 can be monolithically formed, for example, in a single molding step. In some embodiments, the inflatable reservoir 120 can include a first portion and a second portion such that the two portions can be coupled together to define an interior volume for receiving a fluid (e.g., water, saline, and/or air). In some embodiments, the first portion can be formed from an elastic but strong material, e.g., liquid silicone, rubber, or any other elastic material. In some embodiments, the second portion can be made from a flexible, tough and minimally elastic material, e.g., reinforced silicone sheeting. In some embodiments, the first portion and the second portion can be permanently coupled together, e.g., glued (e.g., using RTV silicone adhesive) and/or hot fused. In some embodiments, the inflatable reservoir can be configured to include a first end and a second end, such that when the first end and the second end are proximate to each other, the first and the second end define a channel configured to receive the blood vessel BV, for example, a blood vessel of an immunocompromised non-human animal that has a human fetal organ transplanted thereto. In some embodiments, the inflatable reservoir 120 can be in pressure contact with the blood vessel BV. In some embodiments, the inflatable reservoir 120 can also include a port configured to allow fluid communication between the inflatable reservoir 120 and the fluid delivery mechanism 110. In some embodiments, the port can be a bi-directional port configured to allow two way communication of the fluid between the inflatable reservoir 120 and the fluid delivery mechanism 110. In some embodiments, the inflatable reservoir 120 can be configured to include more than one port, for example, an inlet port and an outlet port.

In some embodiments, the channel defined by the first end and the second end of the inflatable reservoir can be configured to have a first diameter in a first configuration (e.g., less than about 10 mm), and a second diameter in a second configuration, such that the second diameter is less than the first diameter. For example, in the first configuration, the inflatable reservoir 120 does not contain any fluid. In this configuration the channel defined by the inflatable reservoir 120 has the first diameter. A fluid can then be delivered to the inflatable reservoir 120 from the fluid delivery mechanism 110, such that the inflatable reservoir 120 inflates/expands until in the second configuration, the channel defined by the inflatable reservoir 120 has the second diameter which is less than the first diameter. In some embodiments, in the first configuration the inflatable reservoir 120 can be configured to allow unrestricted blood flow through a blood vessel BV disposed therein, and can be further configured to constrict the blood flow through the blood vessel BV in the second configuration. In some embodiments, the channel defined by the inflatable reservoir 120 can be configured to have a series of diameters, for example, a first diameter which allows unconstricted flow through the blood vessel BV, a second diameter that allows constricted flow through the blood vessel BV such that, for example, the blood pressure of the blood flow is in the range of about 25 mmHg-40 mmHg (e.g., compatible with a blood pressure of a fetal organ explanted from a second trimester fetus). Furthermore, the channel diameter can be adjusted to a third diameter such that the third diameter is smaller than the first diameter but larger than the second diameter such that, for example, the blood pressure of the blood flow in the blood vessel BV is in the range of about 35 mmHg-50 mmHG (e.g., compatible with a blood pressure of a fetal organ explanted from a third trimester fetus).

The retainer 130 can be disposed on the inflatable reservoir 120 such that the retainer 130 is configured to position the first end of the inflatable reservoir 120 proximal to the second end of the inflatable reservoir 120. The retainer 130 can be made from a strong and rigid material, e.g., metals (e.g., stainless steel), hard silicon, plastic and other hard composites. In some embodiments, the retainer 130 can have a substantially circular cross-section and can be in pressure contact with the inflatable reservoir 120. In some embodiments, the retainer 130 can be a rigid circular device that has a first end and a second end such that the first end and the second end are proximate to each other, for example, resembling the letter “C”. In some embodiments, the retainer 130 can define an aperture sized and shaped to receive the inflatable reservoir 120. In some embodiments, the retainer 130 can include a first portion and a second portion, which can be coupled together to defined the aperture for receiving the inflatable reservoir 120. In some embodiments, the first portion and the second portion can be pivotally coupled to each other. For example, in a first configuration, the first portion and the second portion are coupled together such that the inflatable reservoir 120 is contacted, engaged or otherwise secured by the retainer 130. In the second configuration, the first portion and the second portion of the retainer 130 can pivot about their pivot mounts such that the inflatable reservoir 120 can be disengaged from the retainer 120. In such embodiments, the retainer 130 can include, for example a locking mechanism (e.g., a snap-fit mechanism) and a release mechanism. The retainer 130 can be configured to ensure that the first end and the second end of the inflatable reservoir 120 remain proximate to each other in the first configuration as well as the second configuration of the inflatable reservoir 120. This can, for example, allow any change in diameter of the inflatable reservoir 120, e.g., from the first diameter to the second diameter as described herein, to be directed towards the channel defined by the inflatable reservoir 120 such that, for example, the inflatable reservoir 120 constricts blood flow in a blood vessel BV disposed therein. In this way, the blood pressure of the blood flow through the blood vessel BV can be controlled, for example, to be less than 80 mmHg.

Having described above various general principles, several exemplary embodiments of these concepts are now described. These embodiments are only examples, and many other configurations of a blood flow control device, systems and/or methods for controlling blood flow in the vasculature, transplanting human fetal organs to non-human animal hosts and growing an organ from a human fetus are contemplated.

FIGS. 2-4 illustrate a blood flow control device 200 for controlling blood flow through a blood vessel. The blood delivery device 200 includes a fluid delivery mechanism 210, an inflatable reservoir 220 and a retainer 230. The inflatable reservoir 220 is configured to receive a blood vessel, for example, a blood vessel of an immunocompromised non-human animal such as, for example, a rat, mice, rabbit, pig, dog, cat, or primate. The inflatable reservoir 120 is further configured to control the flow of blood to a human fetal organ transplanted to the non-human animal, for example, kidney, liver, pancreas, heart, or lung.

The fluid delivery mechanism 210 is configured to communicate a fluid, for example, water, saline and/or air to the inflatable reservoir 220. The fluid delivery mechanism 210 includes a valve assembly 212 which includes a first portion 213 and a second portion 214. The first portion 213 is configured to be coupleable to a fluid source (not shown) such as, for example, a pump, a syringe, and/or reservoir. The first portion 213 can be coupled to the fluid source by, for example, a tube, a pipe or any other suitable conduit. The second portion 214 of the valve assembly 212 includes a bi-directional valve configured to provide a through flow only if a positive or negative pressure is applied. For example, a fluid source can apply positive pressure to communicate a fluid through the valve of the fluid delivery mechanism 210 towards the inflatable reservoir 220, such that when the positive pressure is turned off, the valve 212 prevents the fluid from flowing back towards the fluid source. Said another way, the valve can allow maintaining of fluid volume and/or pressure delivered to the inflatable reservoir 220 without the need for applying a continuous positive pressure by the fluid source. In some embodiments, the valve mechanism 212 can be, for example, an ABS valve, a septum, a flap valve, a membrane valve, an umbrella valve, a duckbill valve, a butterfly valve, or any other suitable valve mechanism.

The second portion 214 of the valve assembly 212 is coupled to a coupling member 216 configured to couple the valve assembly 212 with a fluid communicator 218. The coupling member 216 includes a first portion having a first diameter coupleable with the second portion 214 of the valve assembly 212. The coupling member 216 further includes a second portion having a second diameter smaller than the first diameter such that the second portion is coupleable to the fluid communicator 218. In some embodiments, the coupling member 216 can be coupled to the valve assembly 212 and the fluid communicator 218 via a simple friction mechanism. The fluid communicator 218 can be, for example, a tube, pipe, a percutaneous fill tube, or any/other suitable fluid conduit that defines a lumen for receiving fluid from the valve assembly 212 and communicating it to the inflatable reservoir 220.

The inflatable reservoir 220 is configured to be removably coupleable to a blood vessel, for example a blood vessel of an immunocompromised non-human animal. As shown in FIG. 3, the inflatable reservoir 220 includes a first portion 222 and a second portion 224 such that when the first portion 222 is coupled to the second portion 224, the inflatable reservoir 220 defines an internal volume for receiving a fluid. The first portion 222 can be made from a strong but soft and elastic material, for example, silicone, rubber, polymers and/or combination thereof. The second portion 224 can be made from a flexible, tough and minimally elastic material, for example, reinforced silicone sheeting, or thick rubber. The first portion 222 and the second portion 224 can be permanently coupled together, for example, glued (e.g., using RTV silicone adhesive) or hot fused. As shown best in FIG. 3 the inflatable reservoir 220 includes a first end 223 and a second end 224, such that the first end 223 and the second end 224 define a channel configured to receive a blood vessel, for example, a blood vessel of an immunocompromised non-human animal that has a human fetal organ transplanted thereto. In some embodiments, a surface of the first portion 222 of the inflatable reservoir 220 can be in pressure contact with the blood vessel. The inflatable reservoir 220 also includes a port 227 configured to receive the fluid communicator 218, such that the port allows fluid communication between the inflatable reservoir 220 and the fluid delivery mechanism 210. The port 227 can be a bi-directional port configured to allow two way communication of the fluid. In some embodiments, the inflatable reservoir 220 can include two ports, for example, an inlet port and an outlet port.

The retainer 230 is configured to be disposed on the inflatable reservoir 220 to position the first end 223 and the second end 225 of the inflatable reservoir 220 proximate to each other. The retainer 230 can be made from a strong and rigid material, for example, metals (e.g., stainless steel), hard silicone, plastic, other hard composites or a combination thereof. As shown, the retainer 230 is a rigid circular device that has a first end and a second end that are proximate to each other such that the retainer 230 resembles the letter C. The retained 230 defines an aperture sized and shaped to receive the inflatable reservoir 220 with close tolerance. The retainer 230 is configured to ensure that the first end 223 and the second end 225 of the inflatable reservoir 220 remain proximate to each other when a fluid is communicated into the inflatable reservoir, for example, from the fluid delivery mechanism 210.

Referring now to FIGS. 5A-B the blood flow control device 200 is shown in a first configuration (FIG. 5A) and a second configuration (FIG. 5B). In the first configuration, the internal volume 226 defined by the first portion 222 and the second portion 224 of the inflatable reservoir 220 does not contain any fluid or a first volume of fluid, such that the channel defined by the inflatable reservoir 220 has a first diameter D₁. A blood vessel, for example, a blood vessel of an immunocompromised non-human animal can be disposed in the channel defined by the inflatable reservoir 220, such that a surface of the first portion 224 of the inflatable reservoir 220 is in pressure contact with the blood vessel and allows a first blood flow in the blood vessel, for example, an unconstricted blood flow. A fluid, for example, saline or air, can then be communicated from the fluid delivery mechanism 210, through he fluid communicator 218, and into the internal volume 226 of the inflatable reservoir 220 through the port 227 as shown by the arrow C. The delivered fluid exerts a force on the sidewalls of the first portion 224 and the second portion 226 of the inflatable reservoir 220 causing the reservoir to inflate. The retainer 230 ensures that first end 223 and the second end 225 of the inflatable reservoir 220 remain proximate to each other during fluid communication into the internal volume 226 such that the inflatable reservoir 220 expands in the direction indicated by the arrows E. In other words, the retainer 230 ensures that the expansion of the inflatable reservoir 220 is directed towards the blood vessel disposed within the channel defined by the inflatable reservoir 220. For example, in the second configuration shown in FIG. 5B, the sidewalls of the first portion 224 of the inflatable reservoir expand, such that the channel defined by inflatable reservoir 220 has a second diameter D₂ smaller than the first diameter. This expansion can constrict the blood flow through the blood vessel, for example, to about 250 ml/min or about 1,250 ml/min, and/or reduce the blood pressure to a human fetal organ transplanted to a blood pressure in the range of about 20 mmHg-60 mmHg.

As described herein, in some embodiments, a non-human animal host can include an organ from a human fetus, for example, a fetal kidney, liver, pancreas, heart or lung transplanted thereto, such that the fetal organ is supported by the immunocompromised non-human animal and can receive arterial blood flow from the animal host. For example, FIG. 6 shows a portion of a non-human animal host which includes a human fetal kidney transplanted thereto, such that the fetal kidney is fluidically coupled to an arterial blood flow of the non-human animal host. The fetal organ can be, for example, harvested from a second or third trimester fetus. Furthermore, the blood pressure of the blood inflow from the non-human animal host to the organ can be less than 80 mmHg. In some embodiments, the blood pressure of the blood inflow from the non-human animal host to the fetal organ can be between about 20 mmHg-60 mmHg. In some embodiments, a blood flow control device, for example, the blood flow control device 200, can be used to control the blood inflow from the non-human animal host to the fetal organ such that an artery providing arterial blood inflow from the immunocompromised non-human animal host to the fetal organ is in pressure contact with an inflatable cuff, for example, the inflatable reservoir 222 of the device 200. The human fetal organ (e.g., a kidney) can be coupled to a fluid collection device to collect fluid secreted by the organ (e.g., urine). In some embodiments, the complement cascade of the non-human animal can also be compromised. Any suitable immunocompromised non-human animal host can be used to serve as the host animal such as, for example, pig, rat, mice, primate, or any other suitable animal. In some embodiments, the non-human animal can have a SCID phenotype. The human fetal organ can be maintained in the transplanted state in the immunocompromised non-human animal host for a predetermined period of time such that the human fetal organ obtains part of its growth in the immunocompromised non-human animal. The human fetal organ can then be harvested from immunocompromised non-human animal, for example, for transplanting into a patient in need of the organ.

Although various embodiments have been described as having particular features and/or combination of components, other embodiments are possible having any combination or sub-combination of any features and/or components from any of the embodiments described herein. For example, although some embodiments were described as having a metal retainer, the blood flow control device can also include a strap which can, for example, be secured using Velcro®. In addition, the specific configurations of the various components can also be varied. For example, the size and specific shape of the various components can be different than the embodiments shown, while still providing the functions as described herein.

1. A method for transplanting an organ from a human fetus in a non-human animal host, the method comprising:
fluidically coupling the organ to the blood circulation system of an immunocompromised non-human animal so that the organ receives arterial blood flow from the non-human animal; and
adjusting the blood pressure of the arterial blood flow entering the organ to be compatible with a blood pressure of the organ from the human fetus.

2. The method of claim 1, wherein the blood pressure of the arterial blood flow is less than 80 mmHg.

3. The method of claim 1, wherein the blood pressure of the arterial blood flow is in the range of about 20 mmHg to about 60 mmHg.

4. The method of claim 1, wherein the arterial blood flow entering the organ is less than 250 ml/min when the organ is a heart of the human fetus and the arterial blood flow entering the organ is less than 1250 ml/min when the organ is a kidney of the human fetus.

5. The method of claim 1, wherein the blood pressure of the arterial blood flow is adjusted via a modification of the non-human animal host cardiovascular system.

6. The method of claim 1, wherein the artery of the organ is connected to the host's infrarenal abdominal aorta of the non-human animal host below the level of the inferior mesenteric artery but above the bifurcation of the aorta and wherein the sympathetic vascular tone of the host's lower limbs is reduced via a lumbar sympathectomy.

7.-17. (canceled)

18. A method of growing an organ from a human fetus, the method comprising:
fluidically coupling the organ to an artery of an immunocompromised non-human animal;
disposing a vascular cuff assembly on the artery, the vascular cuff assembly configured to apply pressure to an exterior surface of the artery;
adjusting the blood pressure of the arterial blood flow from a first pressure to a second pressure, the second pressure less than the first pressure.

19. The method of claim 18, wherein the second pressure is compatible with the organ from the human fetus.

20. The method of claim 18, wherein the second pressure is in the range of about 20 mmHg to about 60 mmHg.

21. The method of claim 18, wherein the blood pressure of the arterial blood flow is adjusted from the first pressure to the second pressure for a first time period, the method further comprising:
adjusting the blood pressure of the arterial blood flow from the first pressure to a third pressure for a second time period, the third pressure less than the first pressure and greater than the second pressure.

22. The method of claim 21, wherein the second pressure is in the range of about 25 mmHg to about 40 mmHg.

23. The method of claim 21, wherein the third pressure is in the range of about 35 mmHg to about 50 mmHg.

24. A device for controlling vascular blood flow, the device comprising:
an inflatable reservoir, the inflatable reservoir having a first end, a second end, and a port configured to allow fluid communication between the inflatable reservoir and a fluid delivery mechanism; and
a retainer disposed on the inflatable reservoir and configured to position the first end of the inflatable reservoir proximate to the second end of the inflatable reservoir, the inflatable reservoir defining a channel configured to receive a blood vessel of a non-human animal.

25. The device of claim 24, wherein the channel has a first diameter in a first configuration, and a second diameter in a second configuration, the second diameter less than the first diameter.

26. The device of claim 25, wherein the inflatable reservoir is configured to allow unconstricted flow of blood in the first configuration.

27. The device of claim 25, wherein the inflatable reservoir is configured to constrict the blood vessel to reduce the flow of blood in the blood vessel in the second configuration.

28.-30. (canceled)

31. The device of claim 24, wherein the port is a bi-directional port configured to allow fluid to be delivered to the inflatable reservoir from the fluid delivery mechanism, and to allow fluid to be removed from the inflatable reservoir.

32. (canceled)

33. The device of claim 24, wherein the retainer has a substantially circular cross section and is in pressure contact with the inflatable reservoir.

34. The device of claim 24, wherein the retainer is a rigid circular device having a first end and a second end, and wherein the first end and the second end are proximate to each other.

35. The device of claim 24, wherein the retainer defines an aperture and the inflatable reservoir is disposed in the aperture.

36.-50. (canceled)
